(19) United States
(12) Patent Application Publication
(10) Pub. No.: US 2005/0064247 A1
(43) Pub. Date: Mar. 24, 2005

(54) Composite refractory metal carbide coating on a substrate and method for making thereof

(76) Inventors: Ajit Sane, Medina, OH (US); Jeffrey Lennartz, Cleveland, OH (US); Jon Leist, North Olmsted, OH (US); Daniel Kotabish, Independence, OH (US); John Mariner, Avon Lake, OH (US); Andrew Macey, Medina, OH (US); Douglas Longworth, Brecksville, OH (US); Timothy Hejl, Independence, OH (US); Thomas Devan, Westlake, OH (US)

Correspondence Address: GEAM - QUARTZ;IP LEGAL, ONE PLASTICS AVENUE, PITTSFIELD, MA, 01201-3697, US

(21) Appl. No.: 10/875,861

(22) Filed: Jun. 24, 2004

Related U.S. Application Data
(60) Provisional application No. 60/482,532, filed on Jun. 25, 2003.

(51) Int. Cl. B05D 7/22; B32B 9/00

(52) U.S. Cl. 428/698; 427/230; 428/209; 428/408

(57) ABSTRACT

A composite coating for use on semi-conductor processing components, comprising a refractory metal carbide coating with its surface modified by at least one of: a) a carbon donor source for a stabilized stoichiometry, and b) a layer of nitride, carbonitride or oxynitride of elements selected from a group B, Al, Si, refractory metals, transition metals, rare earth metals which may or may not contain electrically conducting pattern, and wherein the metal carbide is selected from the group consisting of silicon carbide, tantalum carbide, titanium carbide, tungsten carbide, silicon oxycarbide, zirconium carbide, hafnium carbide, lanthanum carbide, vanadium carbide, niobium carbide, magnesium carbide, chromium carbide, molybdenum carbide, beryllium carbide and mixtures thereof. The composite coating is characterized as having an improved corrosion resistance property and little emissivity sensitivity to wavelengths used in optical pyrometry under the normal semi-conductor processing environments.

This patent application claims priority on provisional application U.S. Ser. No. 60/482,532 with a filing date of Jun. 25, 2003.

### FIELD OF THE INVENTION

This invention relates to a composite refractory metal carbide coating on a substrate for use as a component in semiconductor processes, and to a method of forming said coating.

### BACKGROUND OF THE INVENTION

In a process to grow nitride crystals such as GaN, a gaseous hydride source, e.g., ammonia NH₃, is used as a feed source for the growth of the nitride on a substrate such as sapphire. The substrate usually rests oil a block called a susceptor that can be heated by a radiation frequency (RF) coil, resistance heated, or radiantly by a strip heater. The function of the susceptor is to support a substrate, on which a thin film of a functional crystal is deposited or to hold a crucible (usually quartz in the silicon crystal growing process), which is in intimate contact with the crystal melt. The susceptor must also allow for the transfer of heat from the heater to the functional crystal mass. This must be accomplished as uniformly as possible. Accurate control of the thermal environment is critical to the success in fabricating high quality product such as single crystals.

Due to the high temperature capacity and relative chemical inertness properties inherent to graphite, the material is commonly used in the susceptor, as well as other key components in the crystal growing processes for the semiconductor industry including various liners, shields, tubes, crucible susceptors, electrostatic chucks, and the like. For example, graphite is used as susceptors in fabricating GaN based blue diodes, in depositing epitaxial Si on silicon wafers, in evaporating molten metals for molecular beam epitaxy (MBE). Graphite may also be used as a substrate in an electrostatic chuck for clamping a semiconductor wafer to the chuck. Also due to the properties of graphite, it is commonly used as the base substrate for use in “boats” in the ion-implantation process of wafers, flash evaporators, or in Intermetallic Composite boats (“IMC”) for use in vacuum chambers for the physical vapor deposition of metals on various articles ranging from television picture tubs, polymer films, computer parts, molded plastic shapes, and the like.

Graphite however has certain disadvantages including impurities, poor durability in corrosive environment, and the tendency to degrade and microcrack in environments requiring exposure to repeated temperature cycles. Such microcracking and degradation adversely affect dimensional stability and product quality. In addition, contamination of the product may occur by the leaching of impurities from the graphite components or from particulates generated by the degradation of the graphite itself. Semiconductor standards require extremely low levels of impurities in the semiconductor processing system, i.e., allowing substantially no impurities to be incorporated into the semiconductor material, as even trace amounts can alter the electronic properties of the semiconductor material.

Sintered products often do not provide mechanical robustness necessary for rapid thermal cycling whereas coated products can offer the required robustness. In addition, considerations given to the difficulty of manufacturing a sintered part of complex geometry versus the ease of coating a substrate of similar complex geometry often favor coated substrates. Thus, the graphite component is sometimes coated with a refractory coating such as silicon carbide or SiC, silicon nitride, boron nitride, pyrolytic boron nitride and silicon boride. In one embodiment, SiC is used to provide insensitivity to temperature changes. However, the SiC coating tends to degrade in high temperature NH₃ atmosphere, forming Si₃N₄.

In another embodiment of the prior art, the graphite component is coated with another type of refractory coating such as tantalum carbide for longer life, i.e., TaC resists hot NH3 better than SiC wherein SiC shows degradation by forming Si3N4. However, the TaC coating, as produced by the reaction of metal chloride with graphite composition, is typically rich in Ta. Excess Ta can react with nitrogen and/or carbon (serving as a getter for carbon) in the semi-conductor processing environment. In addition, such a coating exhibits variations in emissivity making accurate temperature control very difficult.

In one embodiment of the prior art, e.g., U.S. Pat. No. 6,410,172, articles with a CVD aluminum nitride coating is disclosed for use in the semi-conductor industry in the form of a heating element, a wafer carrier, or an electrostatic chuck. The article may further have one or more graphite elements for resistance heating and/or electromagnetic chucking.

There is still a need for an improved composite coating material for extending the life of components such as susceptors, liners, evaporators, boats, and the like, with desirable properties such as uniformity and high corrosion resistance. There is also a need for components having extended life and high emissivity properties for use in the standard semi-conductor processing environment at high temperatures. There is also a need for coated substrates to replace the sintered components of the prior art.

### SUMMARY OF THE INVENTION

The invention relates to a composite coating for use on articles or components subject to high-temperature and corrosive (harsh) processing environments, the composite coating comprising a refractory metal carbide coating having its surface modified by at least one of: a) carburizing by a carbon donor source for a stabilized stoichiometry, with the metal carbide being selected from the group consisting of silicon carbide, tantalum carbide, titanium carbide, tungsten carbide, silicon oxycarbide, zirconium carbide, hafnium carbide, lanthanum carbide, vanadium carbide, niobium carbide, magnesium carbide, chromium carbide, molybdenum carbide, beryllium carbide and mixtures thereof; and b) a coating layer of a nitride, a carbonitride or an oxynitride of elements selected from a group consisting of B, Al, Si, Ga, refractory hard metals, transition metals, rare earth metals. In one embodiment, the composite coating is characterized as having improved corrosion resistance properties and increased emissivity insensitivity to wavelengths used in optical pyrometry at standard semi-conductor processing temperatures.

The invention also relates to articles or components for use in high temperature/corrosive processing environment, the articles comprising a layer of a nitride, a carbonitride, or an oxynitride of elements selected from a group consisting of B, Al, Si, Ga, refractory hard metals, transition metals, rare earth metals, which nitride layer is coated directly onto the refractory metal carbide substrate of the component.

The invention further relates to a method of forming a composite coating on a substrate for use as a component in harsh processing environments, with the method comprising the steps of (a) precipitating a coating on the component substrate such as a graphite substrate with a metal carbide from the group consisting of silicon carbide, tantalum carbide, titanium carbide, tungsten carbide, silicon oxycarbide, zirconium carbide, hafnium carbide, lanthanum carbide, vanadium carbide, niobium carbide, magnesium carbide, chromium carbide, molybdenum carbide, beryllium carbide and mixtures thereof; and (b) modifying its surface by at least one of the steps: (i) carburizing said metal carbide coating by a carbon donor source for a stabilized surface stoichiometry of the composite coating; or (ii) precipitating another coating of nitride, carbonitride or oxynitride of elements selected from a group consisting of Al, Si, Ga, refractory hard metals, transition metals, rare earth metals. Excess carbon may be further removed from the surface by introducing NH₃ for a limited time period.

The present invention also relates to a processing component comprising a coating of a refractory metal carbide layer with its surface modified by at least one of: (a) carburization by a carbon donor source for a stabilized stoichiometry, with the metal carbide being selected from the group consisting of silicon carbide, tantalum carbide, titanium carbide, tungsten carbide, silicon oxycarbide, zirconium carbide, hafnium carbide, lanthanum carbide, vanadium carbide, niobium carbide, magnesium carbide, chromium carbide, molybdenum carbide, beryllium carbide and mixtures thereof; and (b) a nitride, carbonitride or oxynitride of elements selected from a group consisting of Al, Si, Ga, refractory hard metals, transition metals, rare earth metals. In one embodiment, the processing component show improved corrosion resistance properties and emissivity insensitivity to wavelengths used in optical pyrometry at standard semi-conductor processing temperatures.

Lastly, the invention relates to processing component/hardware in the form of vacuum metallization boats, substrates, liners, evaporators, crucibles, susceptors, heaters, and electrostatic chucks, for use in highly corrosive and high temperature processing environments. In one example, the processing component is an electrostatic chuck/heater, having electrically conductive layers in the form of heating and/or chucking electrode embedded within.

### BRIEF DESCRIPTION OF THE DRAWINGS

FIG. 1 is a graph showing the correlation between the carbon/metal peak heights (as measured by X-ray diffraction) and the weight gain after exposure to corrosive gases in a typical semi-conductor processing environment, for one embodiment of the invention.

FIG. 2 is a micrograph showing one embodiment of the invention, a TaC coating on a graphite substrate.

FIG. 3 is a micrograph of the TaC coating of FIG. 2, after hot NH₃ test at high temperatures.

FIGS. 4 and 5 are micrographs showing comparable SiC coated graphite of the prior art, before and after hot NH₃ test at high temperatures.

FIG. 6 is a graph showing the concentration profiles of graphitic carbon, carbidic carbon, oxygen, and tantalum of a coating according to one embodiment of the invention.

FIGS. 7 and 8 are graphs illustrating and comparing the emissivity response to temperature and wavelength within the temperature range for processing GaN for a refractory metal carbide coating in the prior art, and the refractory metal carbide coating formed in accordance with the present invention.

FIG. 9 illustrates the emissivity as a function of wavelengths at elevated temperatures of an AlN—TaC coated graphite according to one embodiment of the invention.

FIG. 10 is a micrograph illustrating the effect of Ga corrosion on a SiC coated graphite substrate of the prior art.

FIG. 11 is a micrograph showing the insignificant effect of Ga corrosion on the AlN surface according to one embodiment of the invention, after a Ga corrosion test.

FIG. 12 is a micrograph illustrating one embodiment of the invention, an AlN/TaC coating on graphite containing conductive electrode.

### DETAILED DESCRIPTION OF THE INVENTION

Composite Refractory Metal Carbide Coating. The composite refractory metal carbide coating of the present invention can be characterized as a coating material for use in the harsh semiconductor processing environment such as hot ammonia, hot high temperature, hot hydrogen, and the like, the coating material comprising a metal carbide having a surface modified by at least one of: a) carburization by a carbon donor source for a stabilized stoichiometry, and b) precipitating a nitride, carbonitride or oxynitride of elements selected from a group consisting of B, Al, Si, Ga, refractory hard metals, transition metals, rare earth metals.

As used herein, stabilizing the surface stoichiometry of the metal carbide is meant that the maximum value of atomic ratio of carbon to metal is changed (e.g. by processing) to a constant at which the metal carbide is in equilibrium with carbon at the surface level. This definition is different from the conventional definition in which atomic ratios are well defined, i.e., the metal carbide coating is stoichiometric if the equilibrium composition C/Ta ratio is unity (e.g., Ta/C=1). Similarly, by the conventional definition, it is not stoichiometric if the equilibrium composition ratio C/Ta ratio is not unity (e.g., Ta/C>1 or Ta/C<1), with the balance being taken by oxygen, nitrogen or actual non-stoichiometry corresponding to the environment, i.e., temperature, partial pressure of oxygen, nitrogen, carbon containing species, etc.

The metal carbide coating of the present invention can accommodate small concentrations of other non-metallic elements such as oxygen and/or nitrogen without any deleterious effect on corrosion in hot ammonia, hot hydrogen, as expected in a harsh chemical or semi-conductor processing environment.

In one embodiment of the invention, the metal carbide coating deposited on the substrate has a thickness in the range of 0.1 to 100 microns. In another embodiment of the invention, the metal carbides are selected from the group consisting of silicon carbide, tantalum carbide, titanium carbide, tungsten carbide, silicon oxycarbide (SiOC), zirconium carbide, hafnium carbide, lanthanum carbide, vanadium carbide, niobium carbide, magnesium carbide, chromium carbide, molybdenum carbide, beryllium carbide and mixtures thereof. In another embodiment of the invention, the refractory material is a metal carbide selected from the group consisting of tantalum carbide, zirconium carbide, niobium carbide or titanium carbide.

Any of the aforementioned refractory metal coatings can further comprise an element or compound in contact with the processing environment, and which does not substantially react or degrade in the production of semiconductor crystal materials.

The surface of the refractory metal coatings of the invention may be modified by at least one of the following methods:

A. Carburization by a carbon donor. In one embodiment wherein the metal coating is modified by carburization, Applicants have found that when the refractory metal carbide coating has a stabilized stoichiometry on its surface, i.e., the carbide is in equilibrium with carbon at that surface by a carbon donor source, such modified coating surprisingly improves the corrosion resistance of the underlying substrate in a highly corrosive/high temperature atmosphere such as ammonia, and further offers stable optical emissivity (at wavelengths used in optical pyrometry, typically in the range of 600-950 nm) at elevated temperatures.

In one embodiment of the invention, the metal carbide base is modified by a thin film of pyrolytic graphite (in one embodiment of a thickness of less than 1 micron) which is coated over the metal carbide layer as the carbon donor source, for stabilizing the surface stoichiometry of the metal carbide coating such that the carbide is in equilibrium with carbon at the contact surface between the metal carbide coating layer and the pyrolytic graphite film layer.

In one embodiment, the thin film of pyrolytic graphite has a thickness of about 0.1 to 10 microns. In another embodiment, the thickness is in the range of 1-5000 angstroms in thickness, representing a uniform coating, with the nodules being kept to a size below 20 μm.

B. Precipitation of a metal nitride, carbonitride or oxynitride: In another embodiment, the metal coating is modified by the coating/precipitation of an overcoating layer of a metal nitride, carbonitride or oxynitride. Applicants surprisingly found that in environments that include additional reactive agents such as Ga, Al, or other reactive elements or their compounds, the modification of refractory metal carbide coatings by nitride, carbonitride or oxynitride of elements selected from a group consisting of B, Al, Si, Ga, refractory hard metals, transition metals, rare earth metals yield surprisingly high corrosion resistance combined with high stability of emissivity at wavelengths normally used in optical pyrometry at elevated temperatures.

In one embodiment, the choice of such an overcoat is guided by the composition of corrosive environment, the matching of thermal expansion coefficient to that of underlying layers and substrates, cost, ease of coating, etc. In another embodiment, the thickness of the overcoat layer is optimized depending upon the desired thermo-mechanical stability, surface smoothness, the need to eliminate surface defects, etc., on the coating.

Aluminum nitride has a high thermal conductivity (150-200 W/mK), high-temperature stability in ammonia, and resistant to attacks by molten metals such as aluminum, gallium, and the like. In an example of depositing GaN reactive gases, which include Ga precursor such as trimethyl gallium or TMG, or gallium trichloride and ammonia, the use of aluminum nitride overcoating layer on a metal carbide such as TaC not only fulfills corrosion and emissivity requirements, but also provides desired thermo-mechanical stability, i.e., the coating does not spall during repeated heating and cooling cycles.

In one embodiment of the invention, the metal nitride overcoat layer has an aggregate thickness of about 0.1 to 100 microns, either as a single layer or as multiple/successive coating layers.

In another embodiment, the metal nitride overcoating comprises multiple layers of various different metal nitrides, e.g., a boron nitride or boron nitride composite layer in direct contact with the graphite or composite substrate, then an overcoating layer of aluminum nitride on the boron nitride layer. In yet another embodiment, the metal nitride layer(s) comprise embedded heater element(s) or chucking electrode(s) within the layer(s). The chucking electrode may be in the form of a plate or a bipolar electrode. In a third embodiment, the heater element(s) and electrode(s) comprise material selected from electrically conducting metals, ceramics or mixtures thereof, e.g., molybdenum, tungsten, tantalum, SiC, SiC+W, platinum, and graphite.

Processes for forming Metal Carbide Coating: In one embodiment of the invention, the metal carbide coating is precipitated onto the processing component substrate, e.g., a graphite substrate, by chemical vapor deposition (CVD) in a conventional manner by introducing vapors of a metal halide, e.g., metal chloride, with or without a reducing agent such as hydrogen into a heated reactor containing the graphite substrate. The metal carbide coating of the invention may also be coated onto the substrate by other conventional coating methods including the sputtering method, the molecular beam epitaxy method (MBE), the metalorganic chemical vapor deposition method (MOCVD), or the plasma CVD method (PCVD).

In one embodiment of the CVD process, carbon source such as methane may be introduced along with the metal halide vapor to control the C/Ta ratio during deposition. The graphite or carbon containing reactive gas reacts with the metal chloride vapors depositing, e.g., a metal chloride layer on the graphite material. In this manner, any refractory hard metal chloride may be used to deposit carbides of the respective refractory hard metals or their mixtures, e.g., TaC, ZrC, NbC, etc., and optionally similar refractory carbides such as TiC and SiC can be obtained by reacting their halides with carbon substrate or carbon containing gas.

In one embodiment, after coating the underlying substrate with a metal carbide coating layer, such metal carbide layer is modified by a coating of a carbide donor source such as a pyrolytic graphite layer. The pyrolytic graphite film coating may also be formed in a conventional manner, e.g., by chemical vapor deposition such as by the pyrolysis of a carbonaceous gas such as methane gas in a reactor furnace at high temperature using a suitable inert diluent, or by other coating methods such as MBE, MOCVD, or PCVD.

In one embodiment, after the formation/coating of the pyrolytic graphite layer, the coating is further treated at high temperature for a sufficient time period, generally several hours, to carburize the surface of the coating and restore its stoichiometry by means of diffuision of carbon from the surface into the metal carbide so as to reach an equilibrium with graphite. In another embodiment, after the treatment to assure equilibrium with carbon, NH₃ may be introduced into the reactor at the end of the treatment period to remove excess carbon.

In one embodiment, after coating the underlying substrate with a metal carbide coating layer, the metal carbide layer can be modified/coated with a layer of metal nitride, carbonitride, or oxynitride coating in one of many conventional coating processes known in the art, e.g., plasma spray, chemical vapor deposition process, spray pyrolysis, laser assisted chemical vapor deposition, molecular beam epitaxy method (MBE), metalorganic chemical vapor deposition (MOCVD) process, plasma CVD (PCVD), ion plating, ion spraying, and the like.

In one embodiment, ammonia, aluminum chloride, and hydrogen in appropriate ratios are fed into a reactor containing the substrate coated by a metal carbide layer. The deposition/surface modification may be carried out for about 15 to 180 minutes, for an overcoat of about 0.1 to 100 microns thick.

Applications: In one embodiment of an application, the composite refractory coating is to protect and coat components comprising graphite for use in harsh and corrosive processing environments, e.g., semi-conductor or vacuum metallization where exposure to fluorine and chlorine plasmas are common. The composite refractory metal coating may also be used on processing hardware/components which comprise materials other than graphite, e.g., a composite material as taught in U.S. Pat. No. 5,132,145, a high purity carbon/carbon composite material consisting of carbon fiber reinforcements within a carbon matrix as taught in World Patent Application Nos. WO9855238 and WO02072926.

Examples of semi-conductor processing components include substrates, liners, evaporators, crucibles, susceptors, electrostatic chucks, and the like.

In one embodiment, the semiconductor-processing component is a susceptor made from a graphite which has approximately the same coefficient of thermal expansion as the selected metal carbide so that the likelihood of the graphite or metal carbide coating cracking during the crystal growth process is substantially reduced and the lifetime of the processing component will generally be increased.

In another embodiment, the semiconductor-processing component is an electrostatic chuck and/or a heater wherein etch resistance property to a halogen (fluorine or chlorine) and/or oxygen plasma is critical, wherein a layer of aluminum nitride is used to overcoat a pyrolytic boron nitride (PBN) based heater, electrostatic chuck or their combination i.e., graphite heater as the substrate with a PBN coating layer, and then the overcoat of AlN, graphite substrate with PBN coating containing an electrically conducting layer that is overcoated with AlN.

In an example of an electrostatic chuck, heater elements in the form of electrically conductive layers are embedded within electrically insulating metal nitride, carbonitride or oxynitride coatings, so that heating may be provided by passing electrical current through the conductive layers instead of indirectly heating the graphite susceptor. In yet a second embodiment of an electrostatic chuck, the electrically conductive layers are used for supporting and holding a single crystal wafer or equivalent substrate by electrostatic forces. In a third embodiment, the electrically conductive layers are used as “wafer support” (or as a wafer processing platform) for supporting and holding a single crystal wafer or equivalent substrate by electrostatic forces as well as for heating such a wafer or substrate.

Examples of vacuum metallization hardware/components include flash evaporators or IMC boats for use in processes to deposit metals, i.e., aluminum, copper, zinc, gold, silver, etc. onto plastic shapes or articles such as reflectors, TV picture tubes, plastic film for the manufacture of electronic capacitors, and computer monitors.

In one embodiment of the invention, the composite coating of the invention shows excellent resistance to halogen plasma in vacuum coating applications.

In another embodiment of the invention, the composite refractory metal carbide coating is characterized as having an increase in emissivity of at least 30% over a metal carbide coating that has not undergone the treatment of the invention, e.g., not having been carburized by a carbon donor source or coated with a nitride, a carbonitride, or an oxynitride overcoat.

In yet another embodiment, it is found that the novel coating of the invention is relatively insensitive to infrared or visible radiation (wavelength 600 to 950 nm) that is used in optical pyrometry at the semi-conductor processing temperatures.

As used herein, being “insensitive” to radiation at the semi-conductor processing temperature is meant that the coatings of the invention and/or the coated substrates exhibit an emissivity property which varies little (15% or less) over the typical wavelength and processing temperature ranges employed in semi-conductor processing environments. In one embodiment of the invention, the coatings and/or the coated substrates exhibit an emissivity property which varies less than 10% over a wavelength range of 600 to 950 nm. In yet another embodiment, the variance is less than 5%.

### EXAMPLES

The examples below are merely representative of the work that contributes to the teaching of the present invention, and the present invention is not to be restricted by the examples that follow.

The followings are examples illustrating carburizing a composite pyrolytic graphite TaC coating on a graphite substrate.

In all cases, a graphite vacuum furnace is used to produce coatings. The graphite substrates are either suspended or supported in such a way so as to bring them in contact with reactive gases. These gases are injected in the hot zone of the reactor through a water-cooled metallic injector. A mechanical pumping system is used to control pressure in the reactor. In the examples, flow rates expressed in liter per minute are meant to be standard liter per minute.

After exposing the substrates to reactive gases under conditions described in the tables of Examples 1 and 2 below, coatings on the substrates are evaluated by x-ray diffraction and scanning electron microscopy.

### Example 1

This example encompasses a 3-step process and illustrates the coating characteristics as a result of each step.

| | Process Conditions: Temperature, time, | | |
|---|---|---|---|
| | gas & flow rates, pressure (Gas Flows in | | |
| Process Step | slpm; P = pressure) | Substrate | Notes |
| 1. TaC Coating | Heat up 25-2300° C. in 2-4 hours at | Graphite | TaC (15-20 μm thick) |
| on Graphite | low pressures (4-8 mm) under nitrogen | | coating on surface that is |
| | flow (˜2-4 liter per minute) | | Ta rich at the surface with |
| | Inject TaC15 vapors and chlorine | | Ta/C atomic ratio of ˜1.5- |
| | 2300C 100 mm 6 hours | | 1.7 in a 1000 Angstrom |
| | Purge with N2 and cool | | thick surface |
| | | | layer |
| 2. Carburization | Heat Up 25-1600° C. in 60-90 min; | TaC coated | Dark grey color |
| of TaC/Graphite | Ar = 0.5 lpm; P = 0.5 Torr | graphite | graphite nodules at grain |
| | 1600C 20 min; CH4 = 0.5 slpm, Ar = 0; | | boundary. Typical weight |
| | P = 0.5 Torr | | gain = ˜40 mg/100 cm2. |
| | 1600C 2 hrs; Ar = 0.5; P = 0.5 Torr | | (1-2 μm thick) |
| 3. NH3 | Heat Up 25-1400° C.; 20 min; N2 = 0.5, | Carburized | Weight Loss ˜0.75 |
| Exposure | P-250 μ.m | TaC coated | mg/100 cm2. |
| or removal of | 1400C, 20-30 min, NH₃ = 1.5 lpm; | graphite | This step removes excess |
| excess carbon | N2 = 0; P = 500 μm | | graphite on the surface. |
| | Cool Down in N2; P = 250 μm | | (final thickness 1-2 μm) |

As shown in the table, exposure to hot ammonia is adjusted/controlled until excess carbon is removed from the surface.

### Example 2

A graphite substrate is coated with tantalum carbide coating by following process step #1 in Example 1. After checking for coating quality, the coated substrate is heated in a graphite vacuum furnace to 1600° C. in nitrogen. After the temperature is stabilized, methane is introduced for 20 minutes.. This step is followed by diffusion annealing in nitrogen for one hour. In the final step, the coated substrate is exposed to ammonia for a period of 10 minutes as described in Step 3 of Example 1 to remove excess carbon. These steps are repeated five times to build up a strong, coherent, corrosion resistant carbon rich layer of high emissivity. The process temperature may be selected in a range of 1400 to 1800° C. depending on the process time, as lower temperature requires longer annealing time than at a higher temperature. The steps in Example 2 are summarized below.

| Process | | | |
|---|---|---|---|
| Step | Process Conditions | Substrate | Notes |
| Coating | A: Heat up to 1600° C. in | Tantalum carbide | |
| with TaC | 2.5 hours, pressure (2-4 | coated graphite | |
| | mm), nitrogen flow @ 4 | substrate accord- | |
| | slpm ( See example 1 | ing to step 1 in | |
| | above). | Example 1 | |
| Removing | Methane @1 slpm, N₂ @ | | Grey color, |
| excess | 4 slpm, pressure (10 mm) | | thin and |
| carbon | 10 min. (1600C) | | strongly |
| | N₂ @ 4 slpm, pressure | | adherent |
| | ˜10 mm, 1 hour (1600C) | | carbon rich |
| | NH₃ @ 3 slpm, pressure 10 | | tantalum |
| | mm, 10 min (1600C) | | carbide |
| | Repeat above steps for 5 | | coating |
| | times | | |

The coatings produced by example 2 are examined by x-ray diffraction. Four different graphite coupons are processed according to the conditions given in the table. The area in the middle of the coupon (1-10 sq. mm) is examined by x-ray diffraction. Since the graphite film thickness is sufficiently small for x-rays to penetrate through the film, underlying TaC surface is also sampled.

The diffraction pattern shows a small graphite peak along with tantalum carbide (TaC) peak. Therefore, relative peak heights are used to ensure that the deposited layer is graphite (so that TaC surface is equilibrated with carbon) and that its thickness correlates with the weight gain by a coupon. The following table summarizes obtained results:

| | | eight Gain (mg)/Surface Area of Graphite |
|---|---|---|
| Sample | C/Ta ratio | ubstrate area ˜95 cm2 |
| E051 | 0.250 | 0.00263 |
| H | 0.121 | 0.00127 |
| F023 | 0.032 | 0.00033 |
| I026 | 0.202 | 0.00213 |

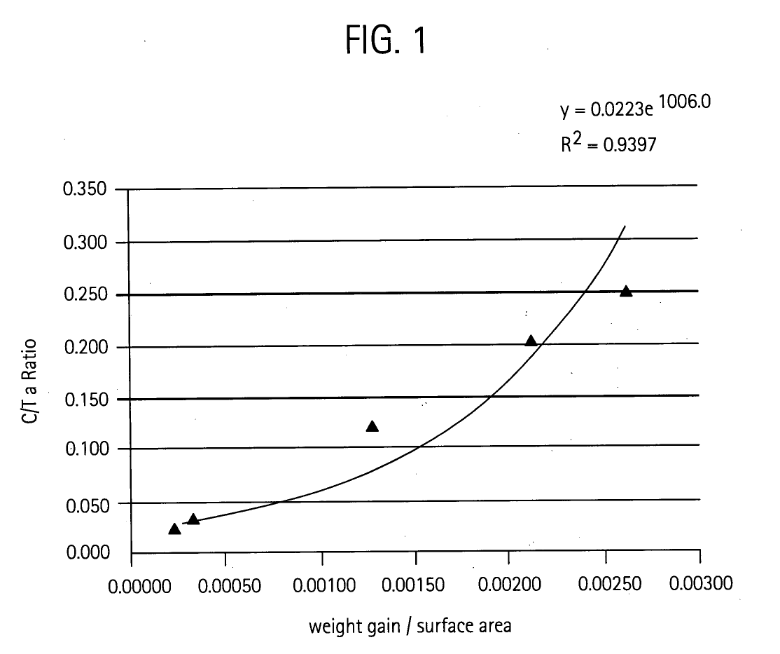

The results of the examples are also illustrated in the Figures. FIG. 1 is a graph illustrating that the weight gain per surface area varies according to the C/Ta ratio of Examples 1 and 2. FIG. 2 is a micrograph of the TaC coating on the graphite substrate prepared according to Example 1.

### Example 3

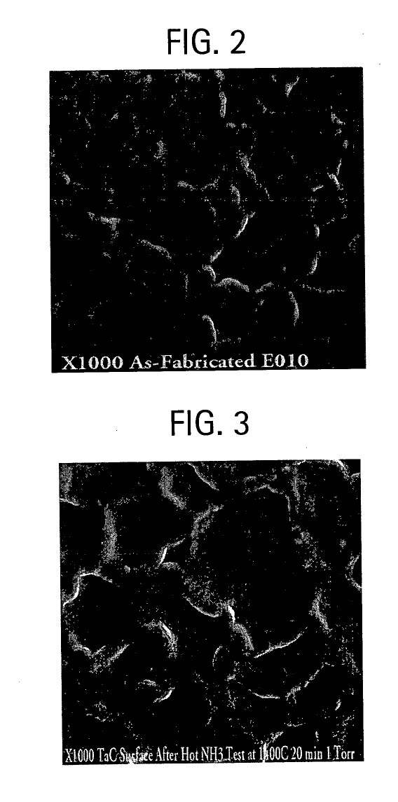

In this example, the coating of Example 2 is exposed to ammonia at 1400° C. for 20 min under 1 torr pressure. FIG. 3 is a micrograph of the TaC coating after hot NH₃ test at high temperatures. Similar to the TaC coating as shown in FIG. 2, the grains of TaC in Example 3 with raised thick grain boundaries are clearly observed in the micrographs, and there is no detectable change in the microstructure as a result of hot ammonia exposure.

### Example 4

SiC is a conventional coating material used in the prior art to protect graphite susceptors during processing of gallium nitride. In this example, samples of commercially available SiC coated graphite are subjected to the same hot ammonia test in Example 3, i.e. exposure to ammonia at 1400° C. for 20 min under 1 Torr pressure. SiC samples are available from various sources, including Graphite Products Corp. of Madison Heights, Mich., USA.

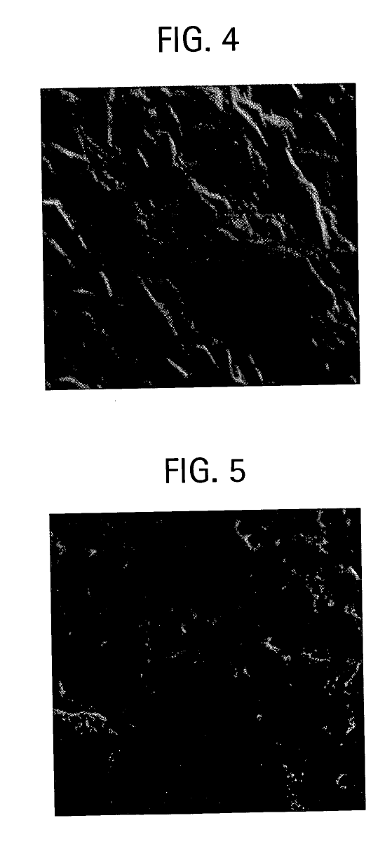

FIG. 4 shows the microstructure of as-received SiC coated graphite (prior to the experiment), FIG. 5 shows microstructures of the SiC coating after the test in Example 4. As shown in these micrographs, the silicon carbide coating of the prior art shows poor resistance to hot ammonia, with the exposed surface showing SiC grains with heavy pitting, i.e., indicating loss of material. This is in contrast with the tantalum carbide coating of the invention as shown in FIG. 3, which does not show any such pitting/corrosion effect.

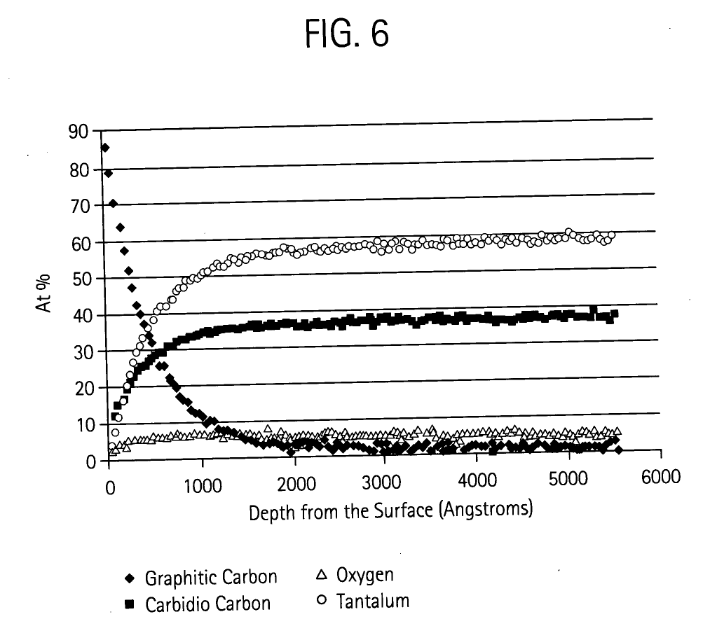

FIG. 6 illustrates the composition profile of the carbon rich surface of the TaC coated graphite according to one embodiment of the invention. In the figure, the surface layer of a coating produced according to Example 1 is first analyzed by x-ray photoelectron spectroscopy. A standard depth profiling procedure is then used to determine the composition of the surface layer. As shown in the figure, the surface contains graphitic carbon shows a steady decrease towards interior. On the other hand, carbidic carbon (carbon that is bonded to tantalum) and tantalum show increase in concentration towards interior. In addition, small amount of oxygen is also detected. Note that the ratio of C/Ta is less than unity in the interior at depths greater than 2000 angstroms.

### Example 5

In this example, the TaC coated substrates of Examples 1 and 2 are examined for optical emissivity at a temperature of ˜1000 ° C., which is in the range that typically corresponds to the processing temperature range of GaN. The emissivity measurements are conducted using a spectrophotometer and black body reference. For a comparative example, a TaC coated substrate of the prior art, i.e., without the effect of carburizing by a carbon donor source, is also tested for emissivity under the same conditions.

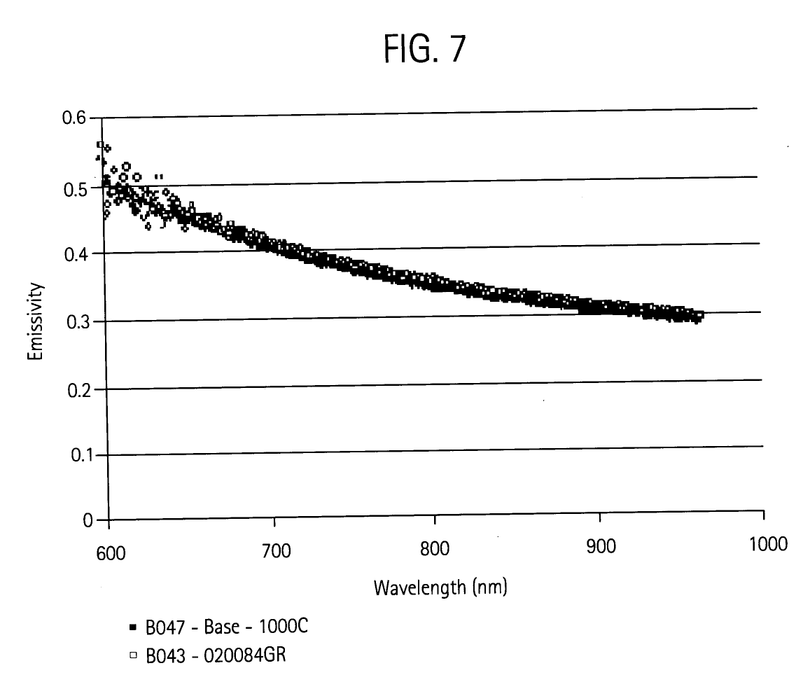

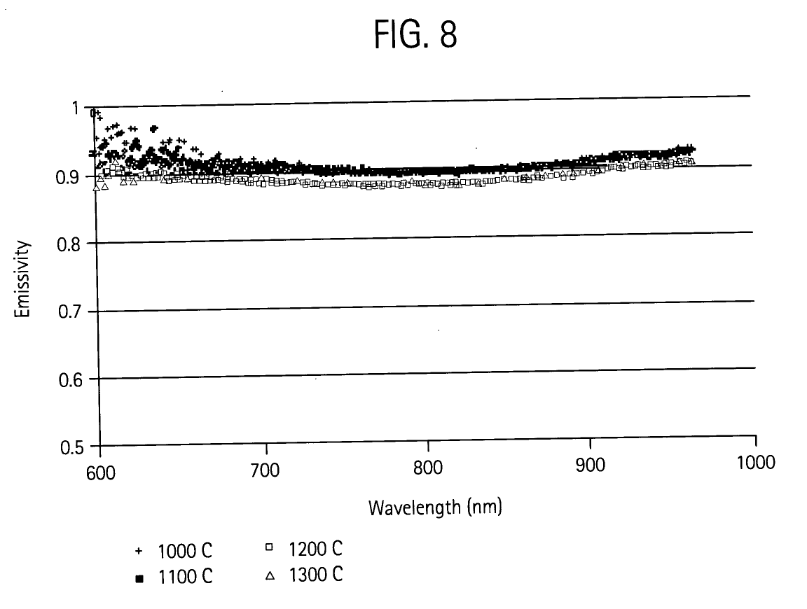

FIGS. 7 and 8 respectively show the emissivity as a function of wavelength for a standard TaC coating and a surface modified TaC coating according to one embodiment of the invention. As illustrated in FIG. 7, the coating emissivity of the conventional metal carbide coating varies with temperature and wavelength, i.e., from 0.3 to 0.55. FIG. 8 shows the surprising results of the present invention, with the new metal carbide coating showing quite high emissivity at high processing temperatures, and at all ranges of wavelengths.

### Example 6

A graphite substrate is coated with TaC under conditions described in process step 1 of Example 1. The coated substrates show the typical metallic gold color found in TaC coated graphite. These substrates are then placed in a graphite vacuum furnace for deposition of aluminum nitride coatings. They are then heated to 1100° C. in nitrogen. After the temperature stabilizes for about 15 minutes, chlorine gas at 2.1 standard liters/min is passed over heated aluminum rods (with temperature in the range of 280-370° C.) and injected into the hot zone of the graphite furnace. In addition, hydrogen at 3.1 slpm, ammonia at 4.5 slpm, and nitrogen at 3.5 slpm are also injected into the furnace.

Care is taken in this example to prevent the premature mixing and deposition of aluminum nitride in the feed system. The deposition of the aluminum nitride at 1100° C. is carried out at a pressure of 1 Torr. After depositing coating for 90 min., all gases except nitrogen are shut off. The furnace power is also shut off.

The substrate is cooled under nitrogen at pressures below 1 Torr. The substrate shows weight gain and a change in color from gold to gray-gold. The average thickness of aluminum nitride is measured to be about 17 μm.

Samples taken from these substrates are used for measurement of emissivity and resistance to corrosion in aggressive environments involving gallium, ammonia, and hydrogen, that are found in growth of GaN film.

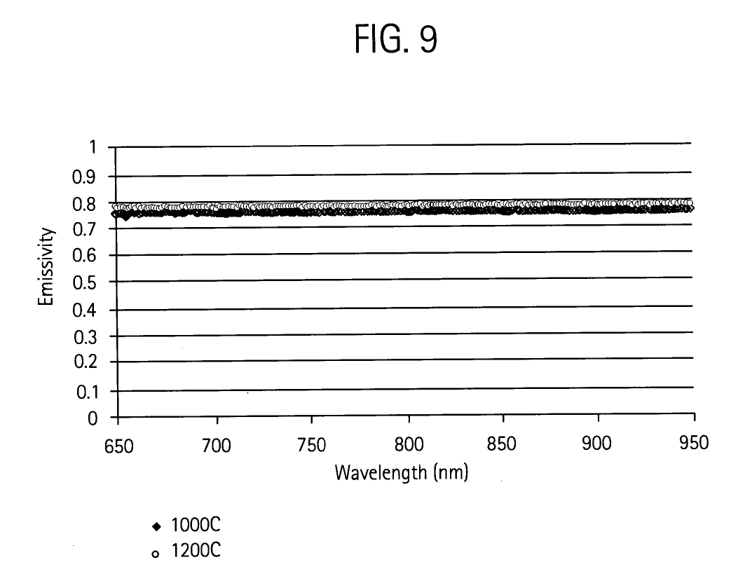

FIG. 9 illustrates the emissivity of the sample prepared according to process conditions in this example (Example 6). The evaluation is conducted at two different temperatures and at wavelengths from 650 to 950 nm. The data clearly shows a marked improvement in emissivity when compared to the emissivity of standard TaC coated graphite (see FIG. 7).

### Example 7

In this example, the sample substrates of Example 6 are exposed to an ammonia and hydrogen mixture at temperatures in the range of 1000 to 1200° C. at pressure of about 1 Torr. The samples do not exhibit any evidence of corrosion as measured by electron microscopy or weight loss.

To test the corrosion resistance in gallium at high temperatures, the samples are placed in pyrolytic boron nitride crucibles and in contact with metallic gallium. For comparison, carbon rich TaC according to Example 1 and commercially available SiC coated graphite are also tested in an identical manner. They are placed in a high temperature vacuum furnace and heated in argon and hydrogen (at a ratio of 1:1) at about 1000-1100° C. and at pressure of 1-3 Torr for one hour. After this soaking period, the temperature is raised to 1260-1300° C. and the pressure is reduced to 60-70 μm to remove any metallic gallium. The samples are then evaluated by scanning electron microscopy for microstructural changes.

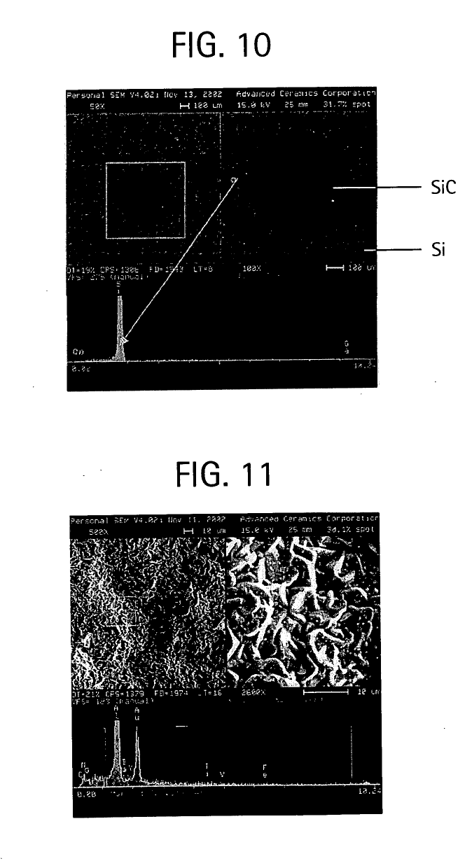

The samples of carbon rich TaC coated graphite show loss of carbon. The SiC coated graphite shows significant loss of carbon from the surface (FIG. 10) while AlN/TaC composite coating does not show any evidence of corrosion (FIG. 11). The gold peak in the energy dispersive x-ray analysis is from gold coating used for microscopy.

As illustrated, the experiments show that presence of gallium along with ammonia during the deposition of GaN can be more corrosive than ammonia alone. In embodiments wherein the composite coating comprises AlN incorporated on TaC coated graphite, superior corrosion resistance properties and high emissivity at wavelengths used in optical pyrometry are obtained compared to the performance of standard TaC or SiC coated graphite substrates.

### Example 8

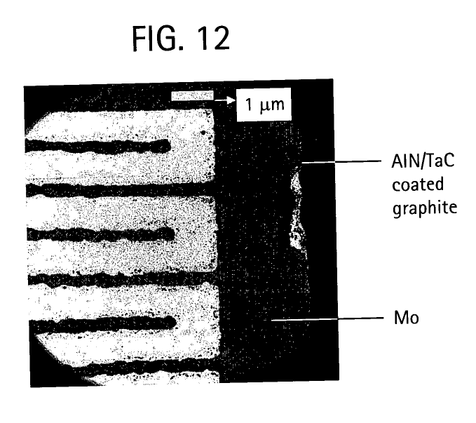

Graphite substrates are first processed according to Example 6 to produce an AlN/TaC composite coating on graphite. These substrates are then coated with an electrically conductive electrode pattern consisting mostly of molybdenum. The pattern is applied by standard silk screening known in the art, followed by a high temperature heat treatment. The conductive electrode pattern is shown in FIG. 12.

Subsequently, the substrates are recoated with aluminum nitride coating. Conditions for both aluminum nitride coatings are illustrated in the table below:

| | Temp. | Pressure | Time | N2 | H2 | NH3 | CI2 | |
|---|---|---|---|---|---|---|---|---|
| Coat | ° C. | mm Hg | min. | slpm | slpm | Slpm | slpm | Notes |
| 1st | 1200 | 0.60 | 90 | 2.7 | 13 | 3.1 | 2.1 | Dense |
| | | | | | | | | adherent |
| | | | | | | | | coating |
| 2nd | 1000 | 0.60 | 160 | 2.7 | 13 | 3.1 | 2.1 | Dense |
| | | | | | | | | adherent |
| | | | | | | | | coating |

The conductive layer is found to be mechanically and electrically intact underneath the 2^{nd} aluminum nitride coating layer.

### Example 9

Graphite substrates are coated with a composite coating of AlN and TaC according to Example 8 above, except that only one layer of aluminum nitride coating is applied. The surface of this coated graphite is then printed with a conductive electrode pattern with a conductive ink. An example of a conductive ink includes TiH₂ powder—3 parts; HOPG (graphite) powder—1 part; W powder (−325 mesh)—4 parts; WC powder—4 parts; and TiC powder—4 parts by weight.

The components are mixed with 1.3% nitrocellulose solution (alcohol base) such that 10 cc. of solution is used for every 3 μm of TiH₂ powder, for the resultant paint to have a sufficiently low viscosity for printing a pattern on the coated graphite.

The samples are then heated to 1570° C. at 3.9 Torr pressure under an argon/hydrogen mixture (flow rates at 1 & 0.3 slpm) for 30 min. After cooling, the metallized surface of the samples shows very strong bonding with the pattern and adhesion, for a conductive layer suitable for electrical heating and/or electrostatic chuck applications.

### Example 10

Graphite coupons are coated with a composite coating of AlN and TaC according to the chemical vapor deposition process in Example 8 above, except that only one layer of aluminum nitride coating is applied. The coupons are tested in molten Ga and NH₃ at about 1100 to 1200° C., along with comparative coupons of TaC/graphite and SiC/graphite without the AlN overcoat layer. It is observed that Ga attacks the TaC/graphite and SiC/graphite coupons by depleting the carbon layer, but little or no attack on the coupons with the AlN overcoat.

### Example 11

PBN based heaters coated with an AlN layer of about 5 to 100 microns are compared with PBN based heaters without any AlN overcoat. The emissivity at about 1000° C. and 800nm is then measured, with an emissivity of about 0.767 observed for heaters coated by AlN as compared to about 0.465 for the uncoated PBN based heaters.

### Example 12

In this example, AlN substrates are coated with at least a coating selected from Ti, W, TiC, SiC, MoC, and then overcoated with an AlN layer. With the proper CTE (coefficient of thermal expansion) match, a strong electrically conducting layer was formed on the coated AlN substrate. This is further coated with another AlN layer for a smooth surface with no cracks observed. The coated substrates when exposed to fluorine and oxygen plasma ( feed gases: CF4+4% oxygen) does not show any significant change in the microstructure that is indicative of corrosion.

While the invention has been described with reference to a preferred embodiment, those skilled in the art will understand that various changes may be made and equivalents may be substituted for elements thereof without departing from the scope of the invention. In addition, many modifications may be made to adapt a particular situation or material to the teachings of the invention without departing from the essential scope thereof. Also, all citations referred herein are expressly incorporated herein by reference.

1. A composite coating for use on semi-conductor processing components, comprising a refractory metal carbide coating having its surface modified by at least one of:
a) carburization by a carbon donor source for a stabilized stoichiometry; and
b) an overcoating layer comprising at least one of a nitride, a carbonitride or an oxynitride of elements selected from a group consisting of B, Al, Si, Ga, refractory hard metals, transition metals, and rare earth metals;
wherein said metal carbide is selected from the group consisting of silicon carbide, tantalum carbide (TaC), titanium carbide (TiC), tungsten carbide, silicon oxycarbide, zirconium carbide (ZrC), hafnium carbide, lanthanum carbide, vanadium carbide, niobium carbide (NbC), magnesium carbide, chromium carbide, molybdenum carbide, beryllium carbide and mixtures thereof.

2. The composite coating of claim 1, wherein said metal carbide is selected from the group consisting of TaC, ZrC, NbC, TiC and mixtures thereof.

3. The composite coating of claim 1, wherein said refractory metal carbide coating is coated by a overcoating layer comprising at least one of a nitride, or carbonitride or oxynitride of elements selected from the group consisting of B, Al, Si, refractory hard metals, transition metals, and rare earth metals.

4. The composite coating of claim 1, wherein said overcoating layer comprises an electrically conducting pattern.

5. The composite coating of claim 1, wherein said refractory metal carbide coating is carburized by a layer of pyrolytic graphite.

6. The composite coating of claim 5, wherein said refractory metal carbide coating has an atomic ratio of carbon to metal that is in equilibrium with carbon.

7. The composite coating of claim 1, wherein said coating has an emissivity insensitive to wavelength and temperature process variables employed in crystal growth environments.

8. The composite coating of claim 1, wherein said the refractory metal carbide coating further comprises non-metallic elements.

9. The composite coating of any of claims 8, wherein the non-metallic elements comprise oxygen or nitrogen in an amount of less than 5 atomic %

10. A semi-conductor processing component comprising the composite refractory metal carbide coating of claim 1.

11. The semi-conductor processing component of claim 10, in the form of a liner, a substrate, a crucible, or a susceptor.

12. A method of forming a composite coating on a substrate for use as a semi-conductor processing component, said method comprises the steps of:
a) precipitating a coating on the semi-conductor component substrate with a metal carbide from the group consisting of silicon carbide, tantalum carbide, titanium carbide, tungsten carbide, silicon oxycarbide, zirconium carbide, hafnium carbide, lanthanum carbide, vanadium carbide, niobium carbide, magnesium carbide, chromium carbide, molybdenum carbide, beryllium carbide and mixtures thereof;
b) carburizing said metal carbide coating by a carbon donor source for a stabilized surface stoichiometry.

13. The method of claim 12, wherein the step of carburizing said metal carbide coating comprising forming a film of pyrolytic graphite on said metal carbide coating.

14. The method of claim 12, further comprising the step of treating said carburized metal carbide coating in an inert atmosphere at a sufficiently high temperature and for sufficient amount of time to further stabilize the surface stoichiometry of said metal carbide coating.

15. The method of claim 14, further comprising the step of removing excess carbon from said carburized metal carbide coating by a gaseous source.

16. A method of forming a composite coating on a substrate for use as a semi-conductor processing component, said method comprises the steps of:
a) precipitating a coating on the semi-conductor component substrate with a metal carbide from the group consisting of silicon carbide, tantalum carbide, titanium carbide, tungsten carbide, silicon oxycarbide, zirconium carbide, hafnium carbide, lanthanum carbide, vanadium carbide, niobium carbide, magnesium carbide, chromium carbide, molybdenum carbide, beryllium carbide and mixtures thereof;
b) coating said metal carbide coating with a surface layer comprising at least one of a nitride, or carbonitride or oxynitride of elements selected from the group consisting of B, Al, Si, refractory hard metals, transition metals, and rare earth metals.

17. The method of claim 16, wherein said refractory metals are selected from the group consisting of W, Mo, Nb, and Ta.

18. The method of claim 16, further comprising the step of forming an electrically conducting pattern on or within the said overcoating layer.

19. The composite coating of claim 1, wherein said coating exhibits an emissivity which varies less than 15% over a wavelength of about 600 to 950 nm.

20. The composite coating of claim 19, wherein said coating exhibits an emissivity which varies less than 10% over a wavelength of about 600 to 950 nm.
